(19) United States
(12) Patent Application Publication
(10) Pub. No.: US 2014/0012706 A1
(43) Pub. Date: Jan. 9, 2014

(54) METHODS AND SYSTEMS FOR PROCESSING ORDERS IN A SUBSCRIPTION BASED BILLING SYSTEM

(71) Applicant: ZUORA, INC., (US)

(72) Inventor: John P. FOERSTER, San Rafael, CA (US)

(73) Assignee: ZUORA, INC., Redwood City, CA (US)

(21) Appl. No.: 13/722,079

(22) Filed: Dec. 20, 2012

Related U.S. Application Data
(60) Provisional application No. 61/579,579, filed on Dec. 22, 2011.

(51) Int. Cl. G06Q 30/04

(52) U.S. Cl. CPC G06Q 30/04
USPC 705/26.81

(57) ABSTRACT

A system of processing subscription based orders in a subscription billing management system. The system includes an order manager component for receiving order details and creating order objects of various types. Each of order object has a plurality of values associated with it, including at least a value identifying the type of order. The system also includes an order queue component for storing and ordering order objects created by the order manager component and a subscription manager component for selecting an order object from the order queue component and initiating actions within the subscription billing management systems. The actions are determined at least in part by type of order.

### CROSS-REFERENCES TO RELATED APPLICATIONS

This application claims the benefit of U.S. Provisional Application No. 61/579,579 entitled “Order Processing for Subscription Based Billing” filed on Dec. 22, 2011 (Attorney Docket No. 126681.0004), the entire disclosure of which, including Appendices A-D, is hereby fully incorporated herein by reference for all purposes.

### BACKGROUND

Many of today's products and services are implemented with an array of components, support services, utilities and computing resources, and each of components has associated costs, including financial costs. As a convenience to their customers, vendors typically attempt to provide a wide variety of pricing options for their products and services, while also simplify pricing for products and services into a single payment or a simple recurring payment. However, the complex, changing nature of the modern business environment can stress such attempts at pricing simplification. For example, different customer usage patterns can mean a flat fee is too high or too low for particular customers.

As pricing becomes more complex, new problems arise including problems associated with resource utilization accounting, pricing configuration, account management and account status presentation. Conventional attempts to address such problems are flawed. For example, some conventional systems are inefficient and/or ineffective. Some conventional systems are insufficiently flexible. Some conventional systems are difficult to configure and/or administer. Some conventional systems fail to clearly communicate account status to customers; for example, such systems may generate account statements that result in a relatively high number of customer queries with respect to amounts owed and/or that are not in accordance with customer expectations.

Modern billing processes in particular, can be complex, and it has become common to use computer systems to support and manage such processes. However, many conventional computer-based billing systems have been designed to handle billing for traditional physical products. For example, a conventional billing system might receive an order for a physical product, relay the order to an appropriate warehouse, be notified when the ordered product is shipped, and then generate a bill for the customer. Some such conventional billing systems can be modified to handle more sophisticated orderables such as configurable products, non-physical products and even some types of services, but the modifications can be ad hoc, inefficient and/or ineffective. Services, in particular, can be associated with complex billing structures that are problematic for conventional billing systems.

Embodiments of the invention are directed toward solving these and other problems individually and collectively.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the invention are directed to a system of order processing within a configurable subscription billing management system (“SBMS”), and its associated methods. The system includes an order manager component for receiving order details and creating order objects of a plurality of order types in accordance with the order details; an order queue component for storing and ordering order objects created by the order manager; and a subscription manager component for selecting an order object from the order queue component and initiating actions within the subscription billing management system, the actions being determined at least in part by the value of the order object associated with the order type of the order object. Each of said order objects has a plurality of values associated therewith, including at least a value associated with an order type from the plurality of order types.

The associated methods include a method of processing subscription based orders within a subscription billing management system. This method includes the steps of receiving order details; creating an order object having a type associated therewith; storing the order objet in an order object queue; selecting the order object from the order object queue; and initiating actions within the subscription billing management system in accordance with the type associated with said order object. The type associated with each order object being one of a plurality of types including at least a new subscription order type, a subscription amendment order type, a subscription renewal order type, a subscription transfer order type, and a subscription cancelation order type.

Other objects and advantages of the present invention will be apparent to one of ordinary skill in the art upon review of the detailed description of the present invention and the included figures.

### BRIEF DESCRIPTION OF THE DRAWINGS

Various embodiments in accordance with the present disclosure will be described with reference to the drawings, in which:

FIG. 1 is a schematic diagram depicting aspects of an example computing environment in accordance with at least one embodiment of a subscription billing management system (SBMS) suitable for use with the present methods and systems

FIG. 2 is a schematic, stack model diagram depicting aspects of an example SBMS suitable for use with the present methods and systems;

FIG. 3 is a schematic diagram depicting aspects of a subscription billing model in accordance with at least one embodiment of the present methods and systems;

FIG. 4 is a schematic diagram depicting aspects of an example set of billing data model objects in accordance with at least one embodiment of the invention;

FIG. 5 is a schematic diagrams depicting aspects of an example set of subscription orders in accordance with at least one embodiment of the invention;

FIG. 6 is a flowchart depicting example steps for order processing in accordance with at least one embodiment of the invention; and

FIG. 7 is a schematic diagram depicting aspects of a non-limiting, exemplary computing architecture suitable for implementing at least some embodiments of the present invention.

### DETAILED DESCRIPTION

Various exemplary embodiments of the present system of order processing are described herein as functioning with a larger subscription billing management system (SBMS). Such exemplary embodiments are described with the specificity necessary to meet statutory requirements. However, this description is intended only to aid a person having ordinary skill in the relevant art in appreciating and understanding the subject matter defined by the claims which follow. Specifically, such a person will understand and appreciate the subject matter defined by the claims to be inclusive of broader, narrower, alternative and/or additional embodiments, which may, for example, include different and/or additional elements or steps than those included in the described exemplary embodiments. In particular, the present systems and methods are applicable to other types of order processing and are not limited to operating within the described SBMS, and may be implemented independently or as part of other types of billing systems. Such a person will further understand that the scope of the claims includes any embodiment of the claimed subject matter implemented by, or used in conjunction with, technologies other than those explicitly described herein, whether existing at the time of invention or later developed. This description should not be interpreted as implying any particular priority, order, or arrangement among or between various elements or steps of the described embodiments, except when such priority, order or arrangement is explicitly defined by the claims.

Various aspects of at least one exemplary embodiment of the present methods and systems are described below. The present methods and systems are generally directed to solving the problems caused by the complexities inherent in managing subscription based billing systems.

A “subscription,” as that term is used herein, may be generally defined as a time-based relationship between a customer and a vendor and may have attributes relating to the cumulative products and services that a customer has purchased from the vendor and may also include attributes relating to information on how the customer is to be charged and invoiced for all subscribed products and services. An “order,” as that term is used herein, may be generally defined as a point-in-time transaction that affects a subscription and may have attributes relating to the booking of the products and/or services that a customer has purchased at a point in time and may also have attributes relating to how a customer is to be charged and invoiced for all subscribed services at that point in time; an “order” can generate, amend, renew, and/or terminate a “subscription.” An “object,” as that term is used herein, may be generally defined as a data structure or other programmatic entity having attributes and behaviors which is useable by a computer program in the course of performing tasks.

In accordance with at least one embodiment of the present methods and systems, effective and efficient order processing for subscription-based billing systems and services is enabled. For example, a quote to a prospective customer may be converted to an order that results in the creation of a subscription. The subscription need not have a termination date, and may be amended, renewed, transferred and/or canceled with corresponding order types. Such orders are at times called “subscription orders” herein in contrast with conventional “product orders.” In accordance with at least one embodiment of the present methods and systems, and in contrast to some conventional billing systems and services, subscription orders do not directly result in bills or invoices, instead subscription orders may create, update or delete subscriptions that are processed by a billing engine to generate invoices. Such points of flexibility can be significant, for example, in enabling workflows that support efficient and/or effective billing with an evolving subscription-based customer relationship.

In accordance with at least one embodiment of the present methods and systems, billing systems and services may further provide order-based financial metrics. In a subscription-based billing system or service, it is expected that multiple orders may be received that affect a subscription throughout its lifetime (which may be many years long). Each such order may correspond to a positive or negative revenue event. For example, an order may affect monthly recurring revenue (MRR) and/or total contract value (TCV) associated with a subscription. The ability to track such metrics can generate information that is significant to interested parties such as business managers, salespeople, investors, auditors and regulators.

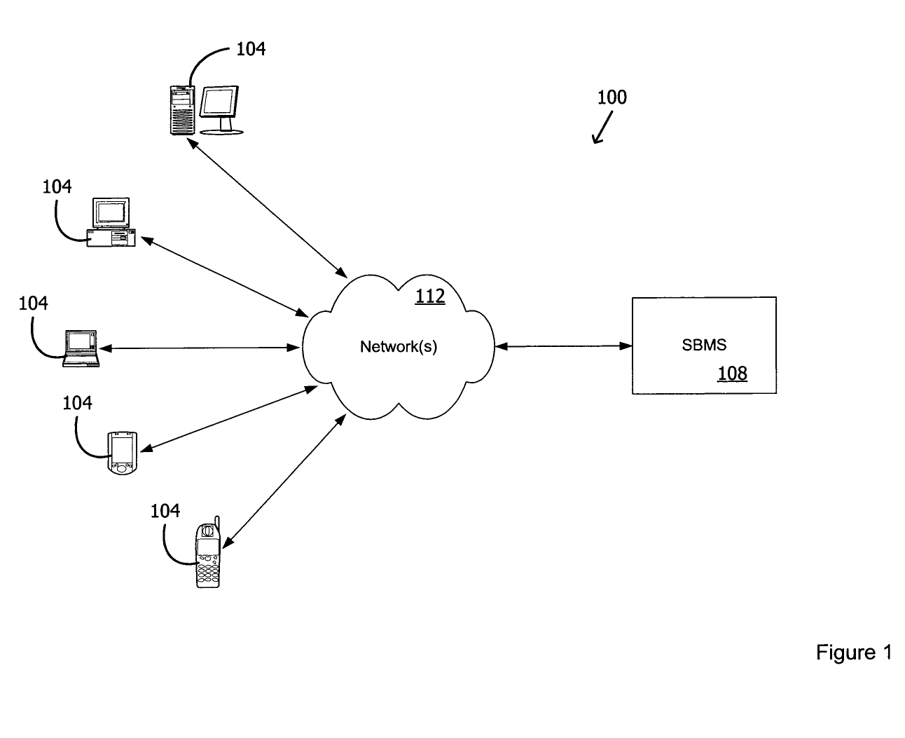

FIG. 1 depicts aspects of an example computing environment 100 for use with at least one embodiment of the invention. A variety of clients (not shown) incorporating and/or incorporated into a variety of computing devices 104 may communicate with a billing service 108 through one or more networks 112. For example, a client may incorporate and/or be incorporated into a client application implemented at least in part by one or more of the computing devices. Examples of suitable computing devices 104 include personal computers, server computers, desktop computers, laptop computers, notebook computers, personal digital assistants (PDAs), smart phones, cell phones, computers, tablets and consumer electronics incorporating one or more computing device components such as one or more processors. Examples of suitable networks 112 include networks including wired and wireless communication technologies and networks operating in accordance with any suitable networking and/or communication protocol.

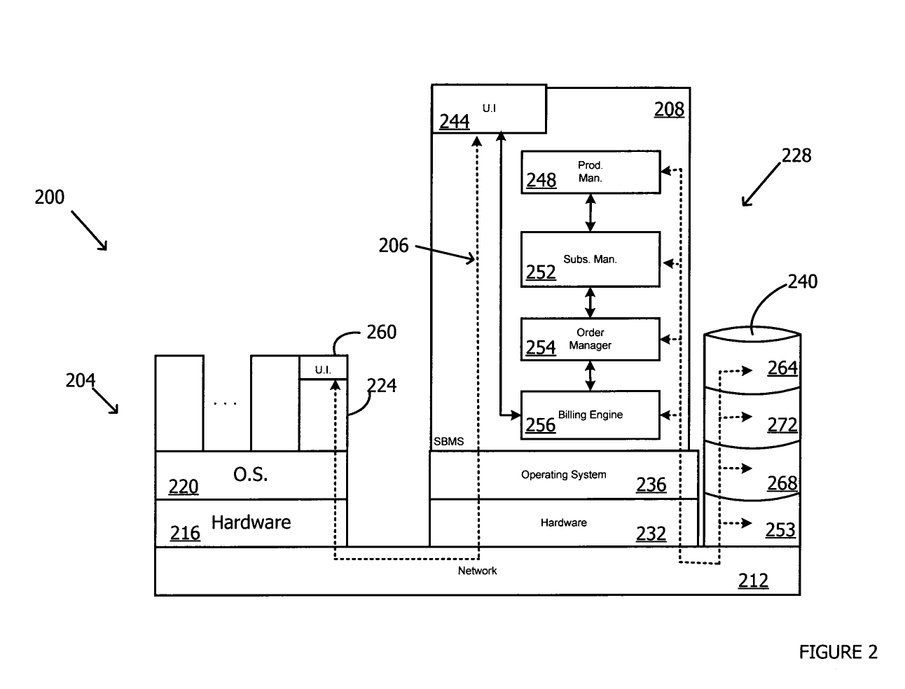

FIG. 2 depicts a conceptual “stack” model 200 of a subscription billing management system (SBMS) hosted on an exemplary computing environment, as shown in FIG. 1. An exemplary computing device 204 is in data communication 206 with the billing service 208 over a network 212. The computing device 204 may include hardware 216, an operating system 220, and a client application 224. The billing service 208 may also be hosted on at least one computing device 228, such as a server, that may include hardware 232 and an operating system 236. Data related to the billing system may be stored in at least one database 240, which may be hosted on a separate computing device (not shown) from the billing service 208.

The billing service 208 may include one or more user interfaces 244, including one or more programmatic interfaces and/or one or more graphical user interfaces (GUIs), configured at least to enable access to functionality of the billing service 208. The billing service 208 may include a product manager component 248 configured at least to enable establishment and maintenance of product and service specifications including associated rate plans and charges. The billing service 208 may include a subscription manager component 252 configured at least to enable establishment and maintenance of customer accounts and associated product subscriptions. The subscription manager component 252 may establish and maintain subscriptions in accordance with orders placed in an order queue 253, which may be maintained in the database 240, by an order management component 254, which may implement aspects of the present methods and systems. The order manager component 254 may be configured at least to enable specification and processing of subscription orders. Types of subscription orders may include new subscription, subscription amendment, subscription renewal, subscription transfer and subscription cancellation. Subscriptions in the order queue may be in a variety of processing states including draft, pending activation, pending acceptance, completed and canceled.

The billing service may further include a billing engine component 256 configured at least to periodically generate charge events in accordance with active subscriptions. The billing engine may be further configured to generate account statements for delivery to subscription customers based at least in part on the generated charge events. Such account statements may be presented to subscription customers and accessible to subscription merchant employees in a variety of formats, including a printed format and an electronic format, for example, through a graphical user interface 244 of the billing service or a user interface 260 of the client application 224. The database 240 may further be divided between data related to product catalogs 264, customer accounts 268, including customer account statements, and customer subscriptions 272.

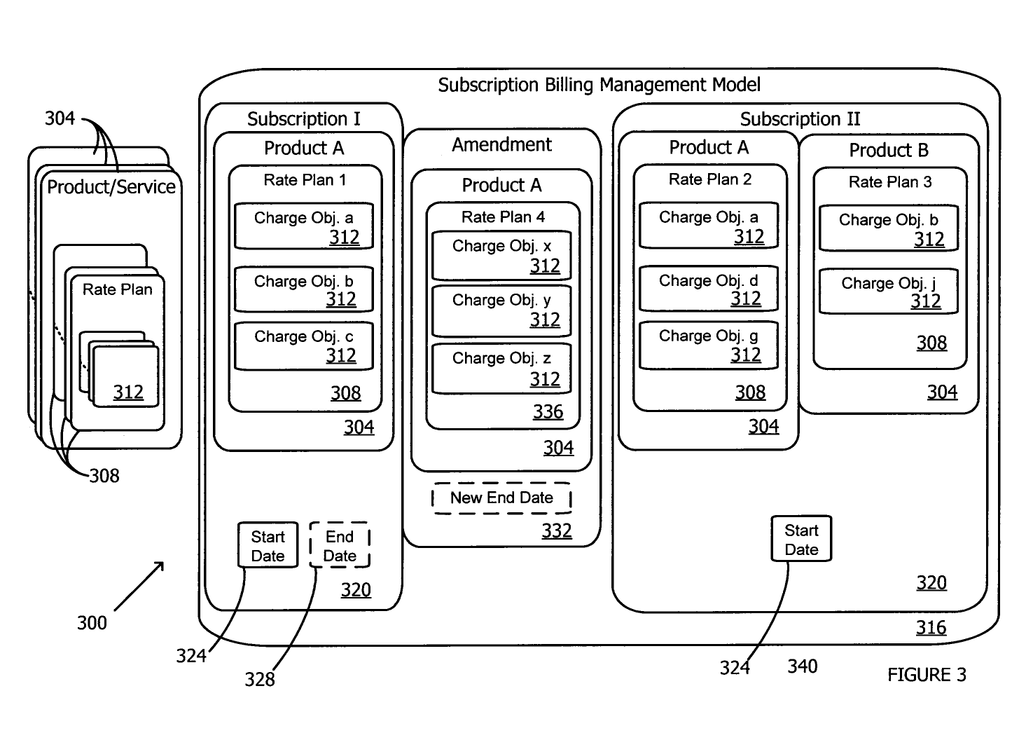

FIG. 3 depicts aspects of an example data model 300 used by a billing service, such as billing service 208, to manage billing data in accordance with at least one embodiment of the present methods and systems. A product 304 may be associated with one or more rate plans 308. A rate plan 308 may be associated with one or more charge objects 312 including one-time charges, recurring charges, usage charges and discounts. A customer or billing account may 316 be associated with one or more subscriptions 320. A subscription 320 may be associated with one or more of the specified products 304 and a selected rate plan 308 for each of the products. Subscriptions may have a start date 324 and an end date 328 (“Evergreen” subscriptions need not have an end date). Amendments 332 may modify an existing subscription 320, for example, to update the end date 328, to modify the set of associated products (not shown), and/or to modify the selected rate plans 336 associated with the set of associated products. Subscriptions 320 may be associated with a set of contract terms and conditions, and subscription amendments 332 may correspond to contract amendments. Subscription versions may be utilized to document subscription amendments.

Subscriptions may correspond to a time-based relationship between a customer and a vendor and/or merchant. Subscriptions may contain and/or reference a cumulative set of products and services that a customer has purchased. Subscriptions may include information on how a customer is to be charged and invoiced for subscribed services (e.g., by referencing and/or including appropriate rate plan and charge objects). Subscriptions with a predetermined end date are called “term” subscriptions. After the end date, term subscriptions may be renewed or allowed to expire. Evergreen subscriptions do not automatically expire. Instead, they continue until a customer or vendor explicitly sets an end date.

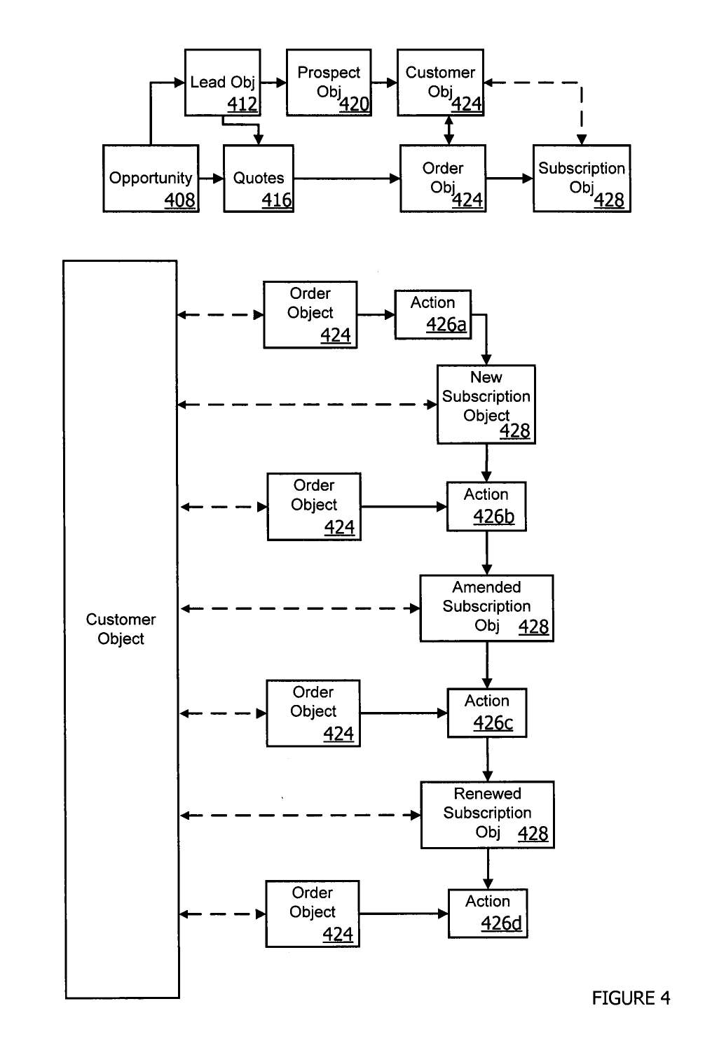

FIG. 4 depicts aspects of an example billing data model 400 and a set of associated data objects 402 in accordance with at least on embodiment of the present methods and systems. An exemplary billing service, such as billing service 208, depicted in FIG. 2, may facilitate a workflow that generates order objects 404, which may, for example, be maintained in an order queue 253. When a sales person identifies an opportunity 408, such as a potential customer, the billing service may generate a lead data object 412 associated with the opportunity 408, in order to provide one or more quotes 416 to the potential customer with respect to products and services in the product catalog (not shown). Upon generating the one or more quotes 416, the lead object 412 may be converted to a corresponding prospect object 420. If the potential customer approves a quote 416, an order object 408 is generated and the prospect object 420 is converted to a customer object 424. Quotes 416 may also be provided to existing customers. Accordingly, in addition to corresponding to new subscription orders, order objects 408 may include orders to amend, renew, transfer and/or cancel existing subscriptions. Order objects 408 associated with order amendments may, for example, relate to product and/or service upgrades, downgrades, suspensions and/or resumptions.

An order object 408 may be associated with a customer object 424 and may, depending on the type of order, cause one or more actions 426a-d to occur with respect to a set of subscriptions 428 associated with the customer object 424. Such actions 426 may include new subscription creation 426a, existing subscription amendment 426b, expiring or expired subscription renewal 426c, transfer of financial responsibility for a subscription to or from the customer (not shown), and the cancellation of a subscription 426d. A billing engine, such as the billing engine 256, depicted in FIG. 2, may process the set of subscriptions 428 associated with the customer object 424 to generate invoices. The billing engine 456 may appropriately pro-rate charges when generating charge events based on associated charge information in the context of a service, statement and/or billing period (collectively “billing period”). Customer payments may be correlated with generated invoices.

Customer accounts may have hierarchical structure. For example, some accounts may be “parent” accounts with respect to “child” accounts. Subscriptions may be associated with parent accounts and/or child accounts. Account statements and/or invoices may be generated with respect to parent accounts and/or child accounts. Service and/or resource utilization may be associated with child accounts and reported (including aggregated and/or summarized) at a parent account level.

As described above, establishment and maintenance of subscriptions may be carried out in accordance with one or more orders place by and/or for the customer. Subscription orders may be associated with one or more order items, each associated with one or more products, rate plans and/or charges. Orders may be a point-in-time transaction that affects a subscription. Orders may record the booking of products and/or services that a customer purchases at a point-in-time. Orders may include information on how the customer is to be charged and/or invoiced for ordered products and/or services. Utilizing orders to establish and maintain subscriptions may enable order-based financial metrics such as per-order bookings metrics. Order objects may provide for ease of use, for example, by billing operators and/or salespeople, as well as for ease of integration with 3rd party systems and services.

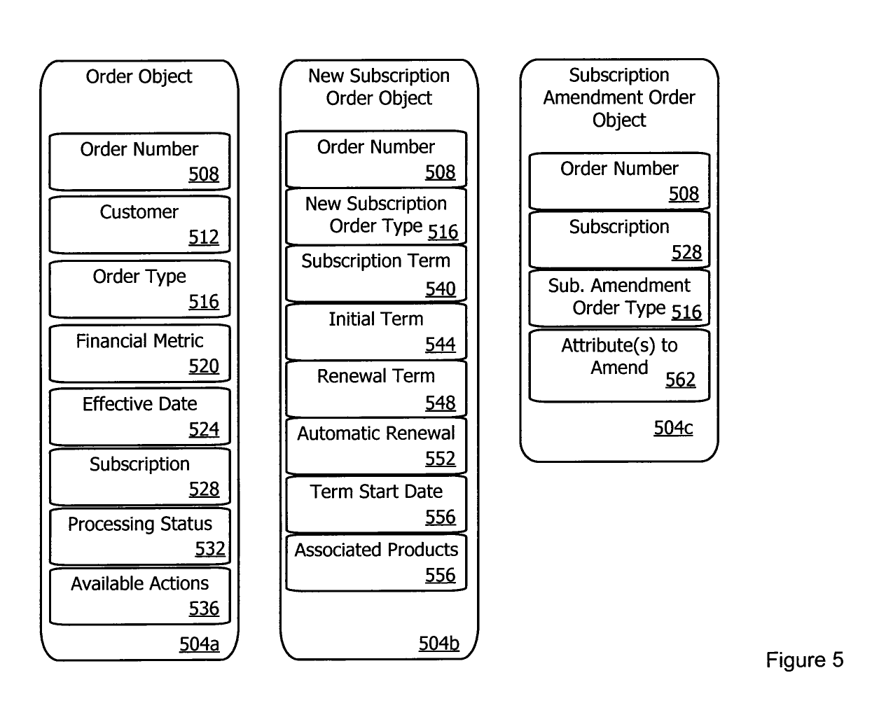

FIG. 5 depict attributes 502 of subscription order objects 504 in accordance with at least one embodiment of the present methods and systems. Referring particularly to order object 504a, for example, an order object 504 may have a uniquely identifying order number 508 (e.g., unique within the billing service). An order object 504 may be associated with a customer 512 (e.g., an entity responsible for ordered products). An order 504 may have a type 516 (as described in more detail below). An order object 504 may be associated with a financial metric 520 (such as a change in monthly recurring revenue). An order object 504 may have an effective date 524 (which may be in the past, present or future). An order object 504 may reference a subscription 528 (e.g., an existing subscription, or one to be created). An order object 504 may be associated with a processing status 532. A variety of actions 536 may be available with respect to order objects 504. For example, order objects 504 may be created, updated and deleted.

Referring particularly to order object 504b, new subscription order objects may specify attributes 502 of the subscription to be created. For example, new subscription order objects may specify the subscription's term 540 (or whether the subscription is an evergreen subscription). If the subscription is to be a term subscription, the new subscription order may specify an initial term 544 and one or more renewal terms 548, as well as whether the term subscription should automatically renew 552. The new subscription order object 504 may specify a term start date 556 independent of an effective date 524 of the order and/or an associated contract. The new subscription order object 504 may include one or more order items 560 such as products, rate plans and/or charges.

Referring particularly to order object 504c, subscription amendment order objects may reference an existing subscription 528, and may specify any suitable attribute 502 or other aspect of the existing subscription to amend 562. Amended subscription attributes may, by way of non-limiting example, correspond to product upgrades, product downgrades, subscription suspensions and subscription resumptions.

Other types of order objects (not shown) include subscription renewal order objects, which may reference an existing subscription as well as a renewal term; subscription transfer order objects, which may reference an existing subscription as well as a new subscription owner; and subscription cancellation order objects, which may reference an existing subscription as well as an optional cancellation reason.

An order object may be in one or more of a number of states. The order object may be in a draft state that stores entered information but which prevents processing of the order before the information is complete and/or the order is approved by the customer. The order object may be submitted and pending. For example, the order may be in the order queue and awaiting processing. The order object may be awaiting acceptance. For example, the order object may have progressed through one or more verification stages to check conformance of the order with requirements and/or availability of resources to fulfill the order. The order object may have a completed status. For example, a subscription associated with the order object may have been created and/or updated.

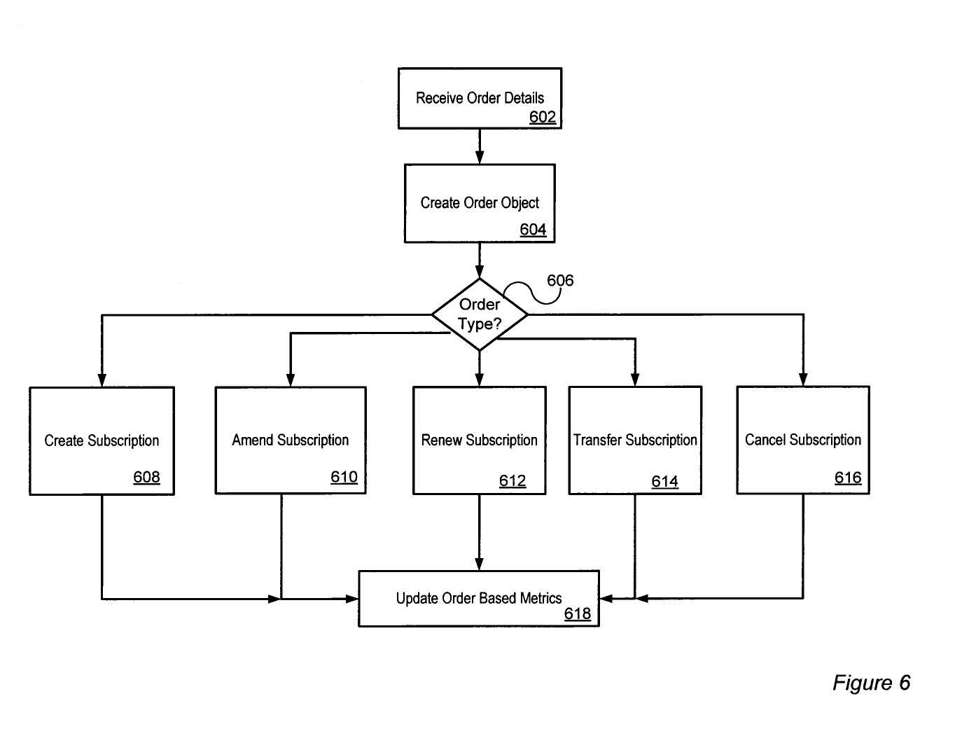

FIG. 6, in conjunction with FIG. 2, depicts example steps for order processing that may be performed by a billing service, such as the SBMS 208, in accordance with at least one embodiment of the present methods and systems. At step 602, order details may be received. For example, the order manager component 254 may receive order details specified by a billing service client 224 through a graphical user interface 244. At step 604, an order object may be created. For example, the order manager component 254 may create the order object in accordance with the received order details and place the new order object on the order queue 253. At step 606, a type of the order may be determined. For example, the subscription manager component 252 may determine the type of the next order in the order queue 253. If the type of the order is “new subscription”, a procedure incorporating step 606 may progress to step 608. If the type of the order is “amendment”, the procedure may progress to step 610. If the type of the order is “renewal”, the procedure may progress to step 612. If the type of the order is “transfer”, the procedure may progress to step 614. If the type of the order is “cancel”, the procedure may progress to step 616.

At step 608, a subscription may be created in accordance with the new subscription order. For example, the subscription manager component may create the new subscription. At step 610, a subscription may be amended in accordance with the subscription amendment order, for example, by the subscription manager component 252. At step 612, a subscription may be renewed in accordance with the subscription renewal order, for example, by the subscription manager component. At step 614, a subscription may be transferred to a new customer in accordance with the subscription amendment order, for example, by the subscription manager component. At step 616, a subscription may be canceled in accordance with the subscription cancel order, for example, by the subscription manager component.

At step 618, one or more order-based metrics may be updated in accordance with the executed order, for example, by the subscription manager component. Alternatively, or in addition, financial metrics, including order-based metrics, may be determined by the billing engine, for example, during and/or following invoice generation. Order-based metrics may be determined based on completed orders in the order queue 253 and/or an order log (not shown).

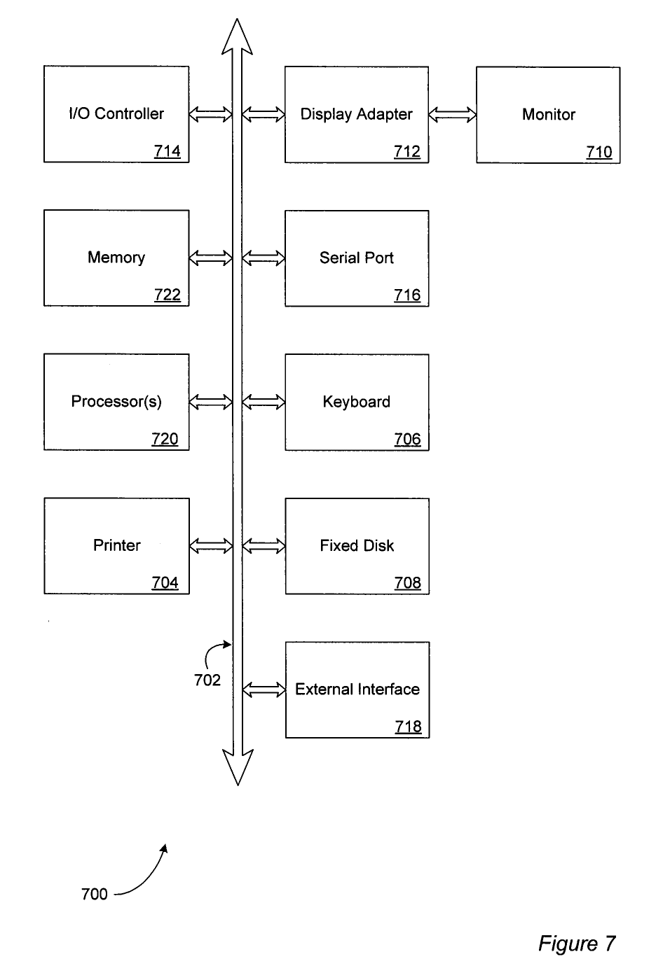

By way of a non-limiting example, FIG. 7 depicts aspects of elements that may be present in an exemplary computer architecture 700 which may be configured to implement at least some embodiments of the present methods and/or processes and/or systems. The architecture 700 includes subsystems interconnected via a system bus 702. The subsystems may include a printer 704, a keyboard 706, a fixed disk 708, and a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to further devices and/or systems not shown in FIG. 7 including a wide area network such as the Internet, a mouse input device, and/or a scanner. The interconnection via the system bus 702 allows one or more processors 720 to communicate with each subsystem and to control the execution of instructions that may be stored in a system memory 722 and/or the fixed disk 708, as well as the exchange of information between subsystems. The system memory 722 and/or the fixed disk 708 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++, or Perl, using, for example, conventional or object-oriented techniques. The software code may be stored as a series of instructions, or commands on a computer readable medium, such as a random access memory (RAM) a read-only memory (ROM), a magnetic medium such as a hard-drive, a solid-state device such as a flash memory drive, or an optical medium such as a CD-ROM. Any such computer readable medium may reside on or within a single computational apparatus, and may be present on or within different computational apparatuses within a system or network.

Exemplary embodiments of the present SBMS have been described in detail above and in the accompanying figures for illustrative purposes. However, the scope of the present SBMS is defined by the claims below and is not limited to the embodiments described above or depicted in the figures. Embodiments differing from those described and shown herein, but still within the scope of the defined SBMS are envisioned by the inventors and will be apparent to persons having ordinary skill in the relevant art in view of this specification as a whole. The inventors intend for the defined SBMS to be practiced other than as explicitly described herein. Accordingly, the defined SBMS encompasses all modifications and equivalents of the subject matter as permitted by applicable law.

That which is claimed is:

1. A system of processing subscription based orders in a subscription billing management system, said system comprising:
(a) an order manager component for receiving order details and creating order objects of a plurality of order types in accordance with said order details, each of said order objects having a plurality of values associated therewith, including at least a value associated with an order type from said plurality of order types;
(b) an order queue component for storing and ordering order objects created by said order manager;
(c) a subscription manager component for selecting an order object from said order queue component and initiating actions within said subscription billing management system, said actions being determined at least in part by the value of said order object associated with the order type of said order object.

2. The system of claim 1, wherein said plurality of order types includes at least a new subscription order type, a subscription amendment order type, a subscription renewal order type, a subscription transfer order type, and a subscription cancelation order type.

3. The system of claim 2, wherein, if said order object is a new subscription order type, said actions initiated by said subscription manager component include at least creating a new subscription object with said subscription billing management system.

4. The system of claim 2, wherein, if said order object is a subscription amendment order type, said actions initiated by said subscription manager include at least modifying an existing subscription object within said subscription billing management system.

5. The system of claim 2, wherein, if said order object is a subscription renewal order type, said actions initiated by said subscription manager include at least modifying a subscription termination date characteristic of an existing subscription object within said subscription billing management system.

6. The system of claim 2, wherein, if said order object is a subscription transfer order type, said actions initiated by said subscription manager include at least modifying an associated billing customer characteristic of an existing subscription object within said subscription billing management system.

7. The system of claim 2, wherein, if said order object is a subscription cancelation order type, said actions initiated by said subscription manager include at least modifying a subscription active characteristic of an existing subscription object within said subscription billing management system.

8. The system of claim 1, wherein said subscription billing management system maintains at least one customer object and at least one related subscription object and said actions initiated by said subscription management component changes the relationship between said customer object and said subscription object.

9. The system of claim 8, wherein said actions initiated by said subscription management component cause a change in an effective term of said subscription object.

10. The system of claim 8, wherein said actions initiated by said subscription management component renews the relationship between said customer object and said subscription object.

11. A method of processing subscription based orders within a subscription billing management system, the method comprising the steps of:
(a) receiving order details;
(b) creating an order object having a type associated therewith;
(c) storing said order object in an order object queue;
(d) selecting said order object from said order object queue; and
(e) initiating actions within said subscription billing management system in accordance with the type associated with said order object; and
wherein said subscription billing management system maintains at least one customer object and at least one related subscription object and step (e) causes changes in the relationship between said customer object and said subscription object.

12. The method of claim 11, wherein said type associated with said order object is one of a plurality of types, said plurality of types including at least a new subscription order type, a subscription amendment order type, a subscription renewal order type, a subscription transfer order type, and a subscription cancelation order type.

13. The method of claim 12, wherein, if said type associated with said order object is a new subscription order type, step (e) comprises creating a new subscription object with said subscription billing management system.

14. The system of claim 12, wherein, if said type associated with said order object is a subscription amendment order type, step (e) comprises modifying an existing subscription object within said subscription billing management system.

15. The method of claim 12, wherein, if said type associated with said order object is a subscription renewal order type, step (e) comprises modifying a subscription termination date characteristic of an existing subscription object within said subscription billing management system.

16. The method of claim 12, wherein, if said type associated with said order object is a subscription transfer order type, step (e) comprises modifying an associated billing customer characteristic of an existing subscription object within said subscription billing management system.

17. The method of claim 12, wherein, if said type associated with said order object is a subscription cancelation order type, step (e) comprises modifying a subscription active characteristic of an existing subscription object within said subscription billing management system.

18. The method of claim 11, wherein step (e) causes a change in an effective term of said subscription object.

19. The method of claim 11, wherein step (e) renews the relationship between said customer object and said subscription object.
